(19) United States
(12) Patent Application Publication
(10) Pub. No.: US 2016/0245985 A1
(43) Pub. Date: Aug. 25, 2016

(54) METHOD FOR MANUFACTURING LIGHT GUIDE PLATE

(71) Applicant: Shenzhen China Star Optoelectronics Technology Co., Ltd., Shenzhen, Guangdong (CN)

(72) Inventor: Yingbo Zheng, Shenzhen, Guangdong (CN)

(73) Assignee: Shenzhen China Star Optoelectronics Technology Co., Ltd., Shenzhen, Guangdong (CN)

(21) Appl. No.: 14/417,829

(22) PCT Filed: Jan. 12, 2015
(86) PCT No.: PCT/CN2015/070548

§ 371 Date: May 6, 2016

(30) Foreign Application Priority Data
Dec. 31, 2014 (CN) 201410856624.3

(51) Int. Cl. F21V 8/00; B29D 11/00

(52) U.S. Cl. CPC G02B 6/0065; G02B 6/0043; B29D 11/00663; B29K 2033/12

(57) ABSTRACT

Related to is a method for manufacturing a light guide plate, comprising the steps of: fabricating, on a smooth surface of a mould, a mould insert used to form optical dots of a light guide plate; coating, on the smooth surface having the mould insert, photoresist, to form a photoresist layer; exposing the photoresist layer, to form the light guide plate; and releasing the light guide plate from the mould. The method can be used to manufacture thin light guide plates, thereby improving ductility of the light guide plates, and reinforcing bending properties thereof, so as to promote development of flexible liquid crystal display screens.

### CROSS-REFERENCE TO RELATED APPLICATIONS

The present application claims benefit of Chinese patent application CN 201410856624.3, entitled “Method for manufacturing light guide plate” and filed on Dec. 31, 2014, the entirety of which is incorporated herein by reference.

### FIELD OF THE INVENTION

The present disclosure relates to the technical field of liquid crystal display screens, and in particular, to a method for manufacturing a light guide plate of a liquid crystal display screen.

### BACKGROUND OF THE INVENTION

In the technical field of liquid crystal display screens, a light guide plate is substantially used to transfer linear light from a light source into surface light, so as to enable homogeneous brightness of a picture displayed on the liquid crystal display screen.

An existing light guide plate is typically made of polymethyl methacrylate (PMMA for short) or polycarbonate (PC for short). The PMMA or PC is injected into a light guide plate mould through injection moulding, and then cured under high pressure to form the light guide plate.

When a thin light guide plate, especially one having a thickness smaller than 0.3 mm, is manufactured through injection moulding, ultrahigh pressures are required to inject the PMMA or PC into the light guide plate mould. Under normal conditions, it is difficult to achieve such ultrahigh pressures in an existing injection moulding device, thus rendering an existing light guide plate thick.

However, an excessive thickness of a light guide plate would severely affect ductility of the light guide plate, thereby restricting development of flexible liquid crystal display screens. Therefore, there is an urgent need of a method for manufacturing a thin light guide plate.

### SUMMARY OF THE INVENTION

In order to solve the above problem, the present disclosure provides a method for manufacturing a light guide plate, through which, a thin light guide plate can be manufactured, thereby improving ductility of the light guide plate, and reinforcing bending properties thereof, so as to promote development of flexible liquid crystal display screens.

The present disclosure provides a method for manufacturing a light guide plate, comprising the steps of: fabricating, on a smooth surface of a mould, a mould insert used to form optical dots of a light guide plate; coating, on the smooth surface having the mould insert, photoresist, to form a photoresist layer; exposing the photoresist layer, to form the light guide plate; and releasing the light guide plate from the mould. An ultrathin photoresist layer can be very easily formed through such a coating manner, and after being cured, can form a thin light guide plate, thereby improving ductility of the light guide plate, and reinforcing bending properties thereof, so as to promote development of flexible liquid crystal display screens.

In one embodiment, the photoresist comprises an acrylic resin and a photosensitizer, a solid content of the acrylic resin accounting for higher than 95% of the photoresist. As has been verified through experiments, when the solid content of the acrylic resin accounts for more than 95% of the photoresist, the photoresist layer would be subjected to a relatively small shrinkage while being transformed into the light guide plate. This would prevent the light guide plate manufactured thereby from being inhomogeneous in thickness.

In one embodiment, parallel light perpendicularly irradiating the smooth surface is used to expose the photoresist layer, so as to ensure homogeneous density of the light guide plate manufactured.

In one embodiment, the parallel light is ultraviolet parallel light. Ultraviolet light has a better stimulation effect, and therefore can accelerate polymerization, shorten polymerization time, and improve productivity.

In one embodiment, the acrylic resin is methyl methacrylate. Under exposure conditions, the photosensitizer can induce polymerization reaction on the photoresist containing methyl methacrylate, whereby low molecular groups polymerize to form macromolecular chains of polymethyl methacrylate, PMMA for short. The light guide plate thus formed can have superior ductility and high spectral transmittance, thereby improving optical performance of the light guide plate and promoting development of flexible liquid crystal screens.

In one embodiment, a release agent is used to soak the mould and the light guide plate, so as to enable complete release of the light guide plate from the mould. Such a manner for release can prevent the light guide plate from being damaged.

In one embodiment, the release agent is hydrochloric acid, nitric acid, or sulfuric acid, and the mould is a plate made of steel or pure iron. Because the guide light plate made of polymethyl methacrylate has stronger acid resistance than the mould made of iron or steel, safety of the light guide plate can be ensured while the mould is being corroded by the hydrochloric acid, nitric acid, or sulfuric acid. As a result, the light guide plate can be removed from the mould in good shape.

In one embodiment, a groove set, which constitutes said mould insert, is formed on the smooth surface of the mould through dot patterning. For example, said groove set is formed on the smooth surface of the mould through a light guide plate dot patterning machine. Such machining dot patterning is beneficial for being simple, reliable, capable of fast processing, and suitable for mass production. Thus, productivity of the light guide plate can be improved.

In one embodiment, the mould is made of stainless steel 430. The mould made of the stainless steel 430 does not easily get rusty, thus ensuring a qualified light guide plate manufactured thereby. Such being the case, the mould can be manufactured in advance, instead of having to be manufactured right before being used.

According the method for manufacturing a light guide plate of the present disclosure, the light guide plate is manufactured through a coating step and a curing step. An ultrathin photoresist layer can be rather easily formed through such a coating step, while the ultrathin photoresist layer, after being cured, can form the thin light guide plate, thereby improving ductility of the light guide plate, and reinforcing bending properties thereof, so as to promote development of flexible liquid crystal display screens. Meanwhile, since the light guide plates thus manufactured has superior ductility, they can be used in curved display screens.

In addition, the method for manufacturing a light guide plate of the present disclosure is simple and reliable, and of low production costs and high processing efficiency, thus facilitating implementations of promotion and use thereof.

### BRIEF DESCRIPTION OF THE DRAWINGS

In the following, the present disclosure will be explained in detail based on embodiments in connection with accompanying drawings, in which:

FIG. 1 shows a flow chart of a method for manufacturing a light guide plate according to the present disclosure; and

FIG. 2 shows a mould used in the method for preparing a light guide plate according to the present disclosure.

In the drawings, the same components are indicated with the same reference signs. The figures are not drawn in accordance with an actual scale.

### DETAILED DESCRIPTION OF THE EMBODIMENTS

The present disclosure will be explained in detail with reference to the embodiments and the accompanying drawings, whereby it can be fully understood how to solve the technical problem by the technical means according to the present disclosure and achieve the technical effects thereof, and thus the technical solution according to the present disclosure can be implemented. It is important to note that as long as there is no structural conflict, all the technical features mentioned in all the embodiments may be combined together in any manner, and the technical solutions obtained in this manner all fall within the scope of the present disclosure.

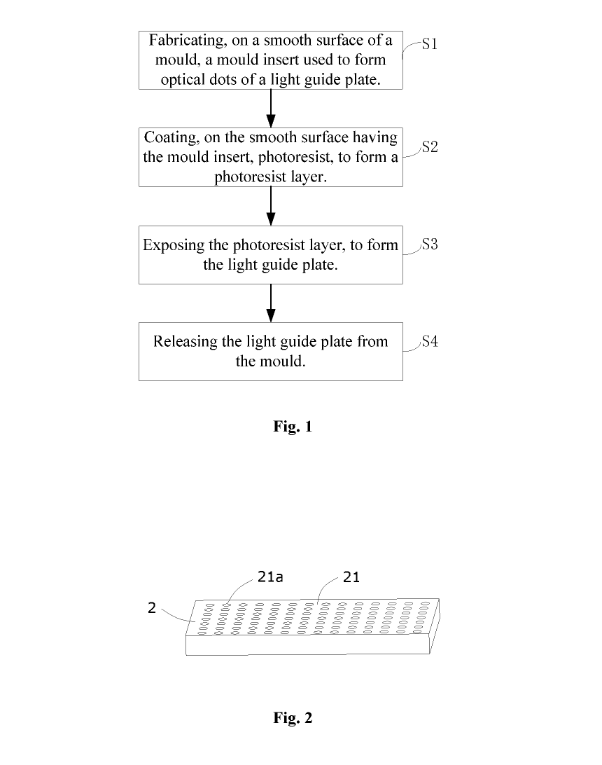

FIG. 1 shows a method for manufacturing a light guide plate, comprising the following steps.

In step S1, a mould insert used to form optical dots of a light guide plate is fabricated on a smooth surface of a mould 2. As shown in FIG. 2, the mould 2 can be substantially formed into a shape of a plate, preferably a rectangular plate the same as the light guide plate. The mould 2 can have two smooth surfaces 21, i.e., an upper smooth surface and a lower smooth surface, and the mould insert can be in the form of a groove set 21a formed on either of the smooth surfaces 21, so as to form the optical dots of the light guide plate. In the groove set 21a, a line connecting each of a plurality of grooves forms a structure similar to a screen mesh. The optical dots are reflective points located on a bottom portion of the light guide plate. The structure of the reflective points is well known in the art, and therefore will not be explained herein in detail.

In step S2, photoresist (also referred to as light latex) is coated on the smooth surface 21 having the mould insert, so as to form a photoresist layer. Such a coating manner includes spray coating, rolling brush, and brushing, whereby an ultrathin photoresist layer can be readily formed. The ultrathin photoresist layer, after being cured, can form a thin light guide plate, thereby improving ductility of the light guide plate, and reinforcing bending properties thereof, so as to promote development of flexible liquid crystal display screens.

In step S3, the photoresist layer is exposed, to form the light guide plate. Polymerization reaction can occur on the photoresist layer under exposure, so as to form a solid state light guide plate.

In step S4, the light guide plate is released from the mould. Heating or soaking with a release agent can be performed to enable complete release of the light guide plate from the mould.

As can be seen, the thin light guide plate can be manufactured through such a method, thereby improving ductility of the light guide plate, and reinforcing bending properties thereof, so as to promote development of flexible liquid crystal display screens. Meanwhile, since the light guide plates thus manufactured has superior ductility, they can be used in curved display screens.

In one embodiment, the photoresist can comprise an acrylic resin and a photosensitizer, a solid content of the acrylic resin accounting for higher than 95% of the photoresist. As has been verified through experiments, when the solid content of the acrylic resin accounts for more than 95% of the photoresist, the photoresist layer would be subjected to a relatively small shrinkage while being transformed into the light guide plate. This would prevent the light guide plate manufactured thereby from being inhomogeneous in thickness. The acrylic resin can be preferably selected as methyl methacrylate. Under exposure conditions, the photosensitizer can induce polymerization reaction on the photoresist containing methyl methacrylate, whereby low-molecular groups polymerize to form macromolecular chains of polymethyl methacrylate, PMMA for short. The light guide plate thus formed can have superior ductility and high spectral transmittance, thereby improving optical performance of the light guide plate and promoting development of flexible liquid crystal screens. The photosensitizer is well known in the art, and therefore will not be explained herein in detail.

In one embodiment, parallel light perpendicularly irradiating the smooth surface can be used to expose the photoresist layer, so as to ensure homogeneous density of the light guide plate thus manufactured. The parallel light can be preferably selected as ultraviolet parallel light. Under normal conditions, ultraviolet light has a better stimulation effect, and can accelerate polymerization, shorten polymerization time, and improve productivity.

In one embodiment, the mould can be a plate made of steel, pure iron, or other hard material. The mould made of steel or pure iron can be beneficial for demoulding. For example, an acid can be used to corrode a mould made of steel or pure iron, so as to facilitate release of the light guide plate from the mould. In one preferred embodiment, the mould can be made of stainless steel 430, so as to prevent rustiness of the mould, which would otherwise affect quality of the light guide plate.

In step S4, the release agent can be used to soak the mould and the light guide plate, so as to facilitate complete release of the light guide plate form the mould. The release agent can be selected based on the material of which the mould is made. For example, an iron or steel mould can be corroded by an acid that can corrode the mould but cannot easily corrode the light guide plate, such as hydrochloric acid, nitric acid, and sulfuric acid, so that the light guide plate can be released readily and completely. Because the guide light plate made of polymethyl methacrylate has strong acid resistance, while the mould made of iron or steel can be easily corroded, the light guide plate can be secured while the mould is being corroded by the hydrochloric acid, the nitric acid, or the sulfuric acid. As a result, the light guide plate can be released from the mould in good shape. Preferably, the hydrochloric acid, the nitric acid, or the sulfuric acid can be selected as a dilute acid.

In one embodiment, the mould insert can be in the form of a groove set, which can be formed through a dot patterning procedure performed either manually or by machine work. For example, a light guide plate dot patterning machine can be used to process the steel or pure iron smooth surface, so as to form the groove set thereon. Such machining dot patterning is beneficial for being simple, reliable, capable of fast processing, and suitable for mass production. Thus, productivity of the light guide plate can be improved. The light guide plate dot patterning machine is well known in the art, and therefore will not be explained in detail herein for the sake of simplicity.

To conclude the above, the method for manufacturing a light guide plate according to the present disclosure can be used to manufacture thin light guide plates, thereby improving ductility of the light guide plate, and reinforcing bending properties thereof, so as to promote development of flexible liquid crystal display screens.

The above embodiments are described only for better understanding, rather than restricting, the present disclosure. Any person skilled in the art can make amendments to the implementing forms or details without departing from the spirit and scope of the present disclosure. The scope of the present disclosure should still be subject to the scope defined in the claims.

1. A method for manufacturing a light guide plate, comprising the steps of:
fabricating, on a smooth surface of a mould, a mould insert used to form optical dots of a light guide plate;
coating, on the smooth surface having the mould insert, photoresist, to form a photoresist layer;
exposing the photoresist layer, to form the light guide plate; and
releasing the light guide plate from the mould.

2. The method according to claim 1, wherein the photoresist comprises an acrylic resin and a photosensitizer, a solid content of the acrylic resin accounting for higher than 95% of the photoresist.

3. The method according to claim 2, wherein parallel light perpendicularly irradiating the smooth surface is used to expose the photoresist layer.

4. The method according to claim 3, wherein the parallel light is ultraviolet parallel light.

5. The method according to claim 4, wherein the acrylic resin is methyl methacrylate.

6. The method according to claim 5, wherein a release agent is used to soak the mould and the light guide plate, so as to enable complete release of the light guide plate from the mould.

7. The method according to claim 6, wherein the release agent is hydrochloric acid, nitric acid, or sulfuric acid, and the mould is a plate made of steel or pure iron.

8. The method according to claim 7, wherein, a groove set, which constitutes said mould insert, is formed on the smooth surface of the mould through dot patterning.

9. The method according to claim 8, wherein said groove set is formed on the smooth surface of the mould through a light guide plate dot patterning machine.

10. The method according to claim 9, wherein the mould is made of stainless steel 430.

11. The method according to claim 1, wherein a release agent is used to soak the mould and the light guide plate, so as to enable complete release of the light guide plate from the mould.

12. The method according to claim 11, wherein the release agent is hydrochloric acid, nitric acid, or sulfuric acid, and the mould is a plate made of steel or pure iron.

13. The method according to claim 12, wherein, a groove set, which constitutes said mould insert, is formed on the smooth surface of the mould through dot patterning.

14. The method according to claim 13, wherein said groove set is formed on the smooth surface of the mould through a light guide plate dot patterning machine.

15. The method according to claim 14, wherein the mould is made of stainless steel 430.
